(19) United States
(12) Patent Application Publication
(10) Pub. No.: US 2026/0225431 A1
(43) Pub. Date: Aug. 6, 2026

(54) ADAPTIVE SHADING WINDOW

(71) Applicant: GM Global Technology Operations LLC, Detroit, MI (US)

(72) Inventors: Tzvi Philipp, Bet Shemesh (IL); Igal Kotzer, Tel Aviv (IL)

(21) Appl. No.: 19/045,077

(22) Filed: Feb. 4, 2025

(51) Int. Cl. B60J 3/04; B60J 1/02; B60J 1/08; G02B 27/01; G06T 7/73

(52) U.S. Cl. CPC B60J 3/04; G02B 27/0101; G02B 27/0179; G06T 7/73; B60J 1/02; B60J 1/08; G02B 2027/0118; G02B 2027/0187; G06T 2207/30201; G06T 2207/30268

(57) ABSTRACT

A vehicle includes at least one window having an electrochromic layer. The at least one window is divided into a set of pixels. A driver facing camera defines a field of view including a driver position. A controller includes a gaze and pose monitoring module and a pixel shading control module. The controller is in communication with the driver facing camera and controllably coupled to the at least one window. The pixel shading control module is configured to identify a position of at least one object reflected from a drivers eye, map the identified position of the at least one object to at least one pixel in the set of pixels, and cause the electrochromic layer to darken the at least one pixel in the set of pixels.

The subject disclosure relates to vehicle windows, and more particularly to a vehicle window configured to be adaptively shaded responsive to lighting conditions.

A common phenomena for drivers traveling in a generally east/west direction during sunrise and sunset is a temporary blindness or reduced vision caused by intense sunlight in the direct view of the driver's eyes. Conventionally, this is avoided through fold-down shaders (visors) that physically block a view of the sun. However, when the sun is low enough on the horizon, the shaders may not be sufficient to fully (or even partially) block the sun. The subsequent temporary blindness may make it difficult to see obstacles in a path of the vehicle and/or difficult to track the road.

In addition to the partial temporary blindness, direct view of the sun, or any similarly bright light source, may result in a significant loss of visual contrast. The loss of visual contrast can make it difficult to distinguish oncoming traffic and/or other road features.

Accordingly, it is desirable to provide a system for adaptively shading windows without obscuring an entirety of the window.

### SUMMARY

In one exemplary embodiment a vehicle includes at least one window having an electrochromic layer. The at least one window is divided into a set of pixels. A driver facing camera defines a field of view including a position of a driver. A controller includes a gaze and pose monitoring module and a pixel shading control module. The controller is in communication with the driver facing camera and controllably coupled to the at least one window. The pixel shading control module is configured to identify a position of at least one object reflected from a drivers eye, mapping the identified position of the at least one object to at least one pixel in the set of pixels, and cause the electrochromic layer to darken the at least one pixel in the set of pixels.

In addition to one or more of the features described herein causing the electrochromic layer to darken the at least one pixel in the set of pixels is performed responsive to a brightness of the reflection of the at least one object exceeding a brightness threshold.

In addition to one or more of the features described herein identifying the position of the at least one object reflected in the driver's eye includes identifying positions of two or more objects reflected in the driver's eye and wherein the mapping of the identified position of the two or more objects to at least one pixel in the set of pixels is performed independently for each object of the two or more objects.

In addition to one or more of the features described herein the at least one window includes a windshield of the vehicle.

In addition to one or more of the features described herein the at least one window further includes at least one side window of the vehicle.

In addition to one or more of the features described herein mapping the position of the at least one object to at least one pixel in the set of pixels includes determining a portion of the at least one window through which the driver sees the reflected object based on a position of the reflection in the driver's eye and at least one of a gaze, head position and pose of the driver.

In addition to one or more of the features described herein each pixel in the set of pixels is uniform shaped.

In addition to one or more of the features described herein each pixel in the set of pixels is one of pentagon shaped and hexagon shaped.

In addition to one or more of the features described herein the controller further includes a path planning and positioning module configured to determine a route of the vehicle and determine an expected future location of a sun based on the route of the vehicle, and wherein a pixel shading control module is configured to shade the expected future location of the sun.

In addition to one or more of the features described herein the electrochromic layer comprises at least an inner glass sub-layer and an outer glass sub-layer coated with a conductive coating, and an inner layer of the electrochromic layer, the conductive coating being controllably coupled to the controller.

In addition to one or more of the features described herein the conductive coating is Indium Tin Oxide (ITO).

In another exemplary embodiment a method for shading a viewing surface in a vehicle includes capturing an image of a driver using an interior facing camera and providing the image to a controller. A position of at least one object reflected in an eye of the driver is identified and the position is mapped to at least one pixel in a set of electrochromic pixels disposed on at least one viewing surface. The electrochromic layer of the identified at least one pixel is darkened responsive to a brightness of a reflection of the at least one object from the eye of the driver exceeding a predefined brightness threshold.

In addition to one or more of the features described herein identifying the position of the at least one object reflected in an eye of the driver comprises identifying positions of two or more objects reflected in the eye of the driver.

In addition to one or more of the features described herein mapping the position of the at least one object to at least one pixel in the set of electrochromic pixels comprises independently mapping the identified position each object of the two or more objects to at least one corresponding pixel in the set of pixels.

In addition to one or more of the features described herein the at least one viewing surface includes a windshield of the vehicle.

In addition to one or more of the features described herein the at least one viewing surface further includes at least one side window of the vehicle.

In addition to one or more of the features described herein mapping the identified position of the at least one object to at least one pixel in the set of pixels includes determining a portion of the at least one viewing surface through which the driver sees the reflected object based on a position of the reflection in the driver's eye and at least one of a gaze, head position and pose of the driver.

In addition to one or more of the features described herein each pixel in the set of pixels is one of pentagon shaped and hexagon shaped.

In addition to one or more of the features described herein, the method includes determining a route of the vehicle and determining an expected future location of a sun based on the route of the vehicle and shading the expected future location of the sun.

In addition to one or more of the features described herein the electrochromic layer comprises at least an inner glass sub-layer and an outer glass sub-layer coated with a conductive coating, and an inner layer of the electrochromic coating, the conductive coating being controllably coupled to the controller.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top down view of a vehicle according to one example;

FIG. 2 is a view of a driver's eye including reflected objects;

FIG. 3 is a schematic side view of the eye of FIG. 2;

FIG. 4 is a system view of an electrochromic windshield;

FIG. 5 is view through a windshield during operation of the electrochromic windshield illustrated in FIG. 4; and

FIG. 6 illustrates a process for operating the electrochromic windshield of FIGS. 4 and 5.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

As used herein, the term controller refers to a system including at least a processor and a memory, with the system being configured to perform or cause to be performed at least one operation. The system can be a dedicated controller including a single purpose processor and memory, a general control including one or more modules for performing the operation, a distributed system including multiple controllers in communication with each other and configured to control the operation, or any similar system.

Electrochromic layers can be included in windshields, windows, and other glass surfaces. These layers can be darkened through the application of electrical voltage differential. By segmenting a glass surface using an Indium Tin Oxide (ITO) coating, or similar conductive coating, pixels can be formed where the voltage differential is applied to selected pixels, and the selected pixels are darkened without darkening the entire glass surface. The darkening does not render the glass fully opaque, and intense light sources (e.g. the sun) can be transparent through the darkening.

By applying the pixel grid to a windshield, or similar surface of a vehicle, and mapping a position of intense light sources such as the sun, relative to a driver's gaze, on the windshield, a controller can selective shade or darken only the portions of the windshield in which the intense light source is visible to the driver.

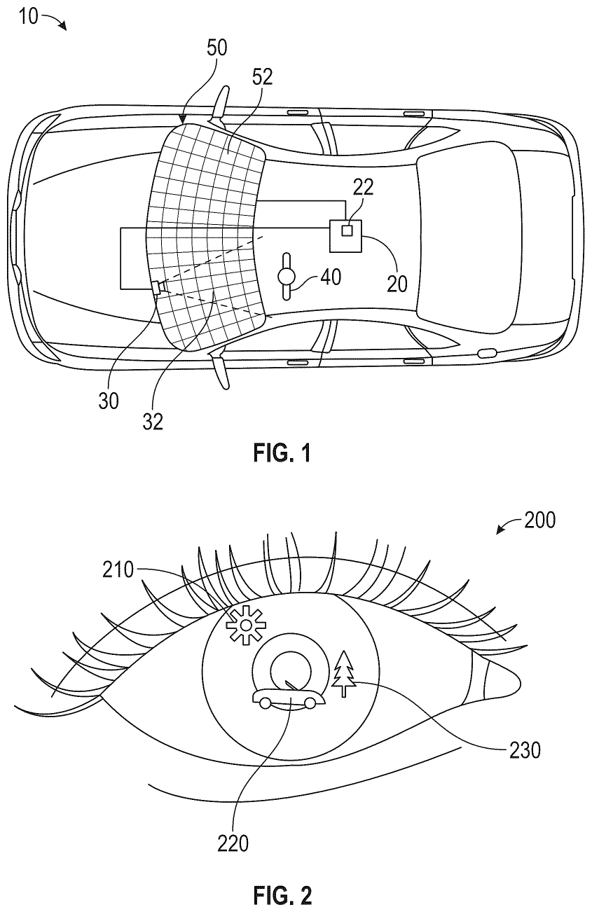

In accordance with an exemplary embodiment, FIG. 1 illustrates a vehicle 10 including a controller 20 and a driver facing camera 30 in communication with the controller 20. The driver facing camera 30 defines a field of view 32 including a driver 40. The field of view 32 facilitates operation of a driver gaze and pose tracking module 22 within the controller 20. The driver gaze and pose tracking module 22 may operate according to any conventional driver gaze and pose tracking methodology to monitor the face of the driver 40 and track the pose, gaze and/or head orientation of the driver 40.

The vehicle 10 includes a windshield 50. The windshield 50 includes an electrochromic darkening function by which one or more pixels 52 (separate regions on the windshield 50) are independently darkened. Standard safety windows for automotive applications use a three-layer structure that includes an outer glass layer, a middle plastic layer, such as polyvinyl butyral (PVB), and an inner glass layer.

The windshield 50 of the exemplary vehicle 10 is distinct from the standard safety windows through the positioning of an electrochromic layer in between the standard layers. The electrochromic layer allows for portions of the windshield 50 to be darkened (alternately referred to as shaded) while still being transparent. The electrochromic layer includes at least an inner glass sub-layer and an outer glass sub-layer of glass or plastic coated with a conductive coating, such as Indium Tin Oxide (ITO), and the inner layer of the electrochromic coating (which may be made of multiple metallic layers depending upon the details of the design). The windshield 50 is separated into regions (pixels 52) and the shading of each pixel 52 is controlled separately.

When a voltage is applied to a given pixel 50 by the controller 20 (using the ITO coating), the electrochromic layer within that pixel 50 darkens. In some cases, the electrolytes within a pixel 52 require a length of time (delay) to transition to the darkened state after initially receiving a charge. In such examples, the delay is a function of the size of the pixel 52. For automotive use, the delay should be sufficiently low that the transition occurs quickly enough to avoid temporary blindness resulting from a bright object. As the speed at which any given pixel 52 darkens or lightens depends partially on the size of the pixel 52, one solution to the transition speed is the utilization of small pixel 52 sizes. The use of small pixels 52 further allows for more granular control and positioning of the shaded regions.

In alternate implementations, when the vehicle 10 has a path planned by the controller 20, the controller 20 may use the panned path combined with route information and localization of the vehicle with GPS information to determine the location of the sun relative to the vehicle 10 for any given time in advance. In addition, using a detected head-pose and eye gaze, the controller 20 can identify which region of the windshield 50 (or other window) is being viewed by the driver, and the position of any reflected objects within that region can be extrapolated. Using this mapping the controller 20 can darken pixels 52 located in these regions in advance before the position of the sun moves into the pixel 52.

While illustrated in the example of FIG. 1 using rectangular pixels 52, it is appreciated that alternative shapes may be utilized instead. In one particular example, the pixels may be pentagon or hexagon shaped, more closely approximating the round shape of expected bright light sources (e.g., the sun).

In one example implementation, the controller 20 uses the driver gaze and pose tracking module 22 combined with corneal reflections in the driver's eyes, as captured by the camera 30, to determine a brightness of an object (e.g. the sun, oncoming vehicle headlights, etc.) as well as a position on the windshield 50 where the light is passing through the windshield 50.

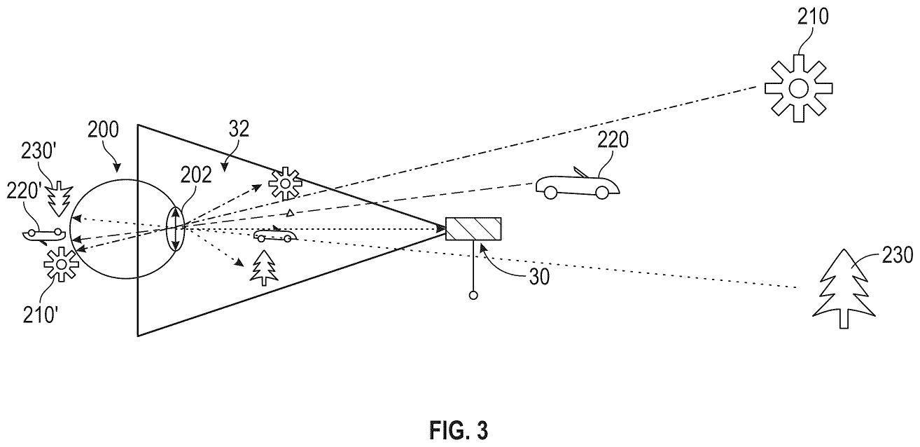

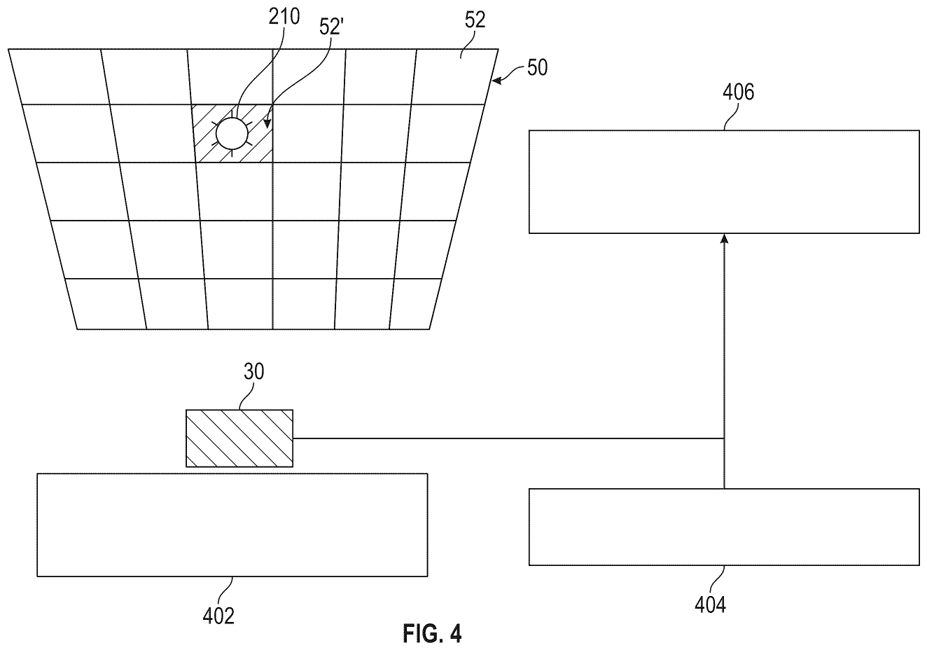

With continued reference to FIG. 1, FIG. 2 illustrates a view of an eye 200, as captured by the camera 30. FIG. 3 provides a schematic representation of multiple objects being reflected from the eye 200. FIG. 4 provides an example operation of the vehicle 10, using the information of FIGS. 2 and 3, to shade a specific pixel 52 or pixels 52.

Reflected from the eye 200 are multiple objects, including the sun 210, a car 220 and a tree 230 (referred to generally as objects 210, 220, 230). The positioning of the reflection of each object 210, 220, 230 on the eye 200 is dependent on the gaze and pose of the eye 200 as well as the position of the objects 210, 220, 230 relative to the vehicle 10. In practice an image of each object 210, 220, 230 is focused on the back of the eye 200 through the lens 202 of the eye 200 and reflected by the cornea as a set of reflections 210′, 220 230′ (FIG. 3). The reflections 210′, 220′, 230′ reflect from the front surface of the cornea, and are visible within the field of view 32 of the camera 30. The particular positioning and orientation of the reflection 210′, 220′, 230′ is dependent on the locations of the objects 210, 220, 230 and the brightness of the reflection 210′, 220′, 230′ is dependent on a brightness of the object 210, 220, 230 itself.

The image of the eye 200 is captured and provided to the controller 20 in an image capture process 402 (FIG. 4).

The images from the camera 30 are provided to the controller 20 and combined with gaze and pose detection from the gaze and pose tracking module 22 to identify at least one pixel 52′ on the windshield 50 corresponding to each object 210, 220, 230 in a combine images with head pose and eye gaze information process 404. In the case of larger objects 210, 220, 230, or individual objects 210, 220, 230 taking up more space on the window, the controller 20 may identify multiple pixels 52 corresponding to the object 210, 220, 230.

After identifying the corresponding pixels 52, the controller compares a brightness of each reflection 210′, 220′, 230′, and any reflections 210′, 220′. 230′ with brightness over a predetermined threshold are determined to be too bright. The particular brightness threshold may depend on additional vehicle factors and can be set by one of skill in the art during a design process. In alternate examples, the vehicle 10 may include an ambient lighting sensor and the particular brightness threshold may be dependent on the current ambient lighting resulting in a dynamic threshold. The dynamic threshold allows the threshold to account for current conditions (e.g., night, day, fog, etc.). In such examples, the shading may be applied to light sources that are relatively bright and is not limited to the sun.

The pixels 52 corresponding to the objects 210, 220, 230 that are too bright are shaded using the electrochromic layer of the windshield 50. The shading is achieved using a voltage control process 406, where a voltage is applied via the conductive ITO strips applied in the windshield 50.

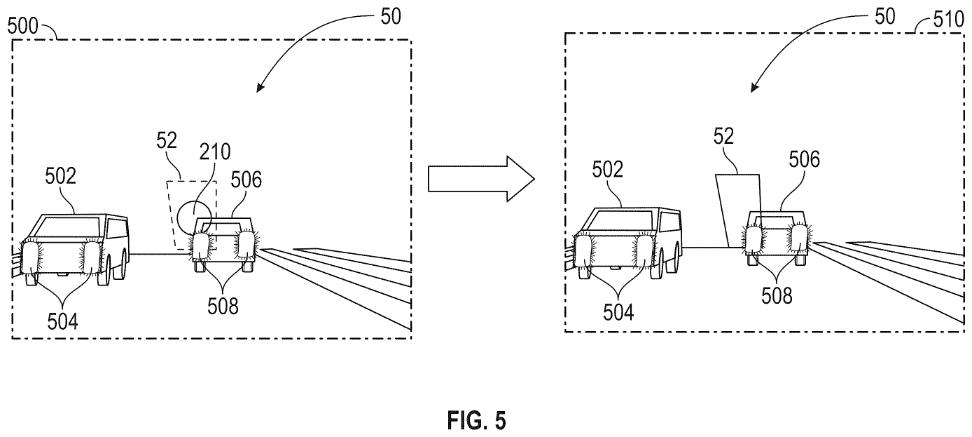

With continued reference to FIGS. 1-4, FIG. 5 illustrates views 500, 510 through the windshield 50 during operation of the system of FIGS. 1-4. As the ITO conductors are not visible to the driver and other occupants of the vehicle 10, the windshield 50 initially appears to be an unshaded clear window. Within the view 500 is an oncoming car 502 including two headlights 504, and a leading car 506 traveling the same direction as the vehicle 10. Visible on the leading car 506 are a set a tail lights 508. The sun 210 is directly in front of the leading car 506. Due to the brightness of the sun, the sunlight obscures a portion of the leading vehicle 506.

Upon detection of the brightness of the sun 509, the system identifies the corresponding pixel 52 in the windshield and shades the pixel 52 resulting in the second view 510. In the second view, the shading in the pixel 52 dims the brightness of the sun 210, while providing transparency that allows the leading car 506 to be fully visible. As the other light sources (oncoming headlights 504 and leading tail lights 508 do not exceed the brightness threshold, the corresponding pixels of the windshield are not shaded and the light sources remain visible.

The process of identifying object reflections and shading corresponding pixels 52 is iterated continuously during operation of the vehicle 10.

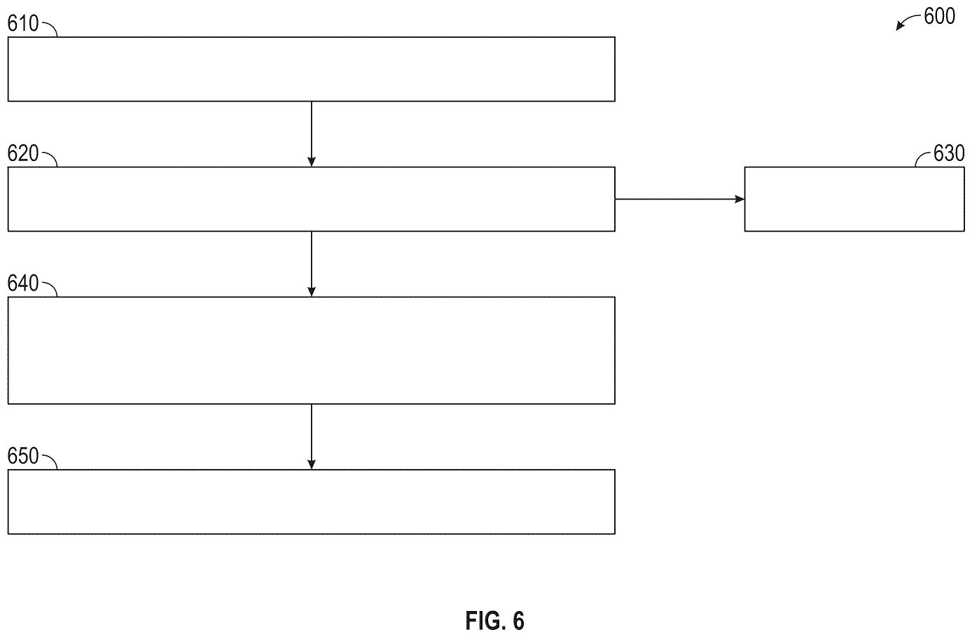

With continued reference to the systems and structures of FIGS. 1-5, FIG. 6 illustrates a flow chart of a process 600 for operations of the systems of FIG. 1.

Initially, the camera 30 captures an image of the driver's eye in a capture image of eye step 610. The image includes eye reflections from visible light, and the controller 20 process is the image to identify each object reflected from the eye.

Once identified, the objects are compared to a brightness threshold, and objects exceeding the brightness threshold are selected for further processing in an object selection step 620. When no objects exceed the brightness threshold, the process 600 ends in an end step 630.

When at least one object exceeds the brightness threshold, the process 600 identifies the head pose, gaze, and head orientation in a map objects to windshield step 640. The pose, gaze and orientation are mapped to the windshield, and each object exceeding the brightness threshold is mapped to one or more pixels corresponding to the location of the reflection from the eye.

The controller 20, that triggers the corresponding pixel or pixels to darken on the windshield in a darken pixels step 650.

As the vehicle 10 moves, the drivers gaze, head orientation, and head pose, and/or the reflected objects move, the process 600 is iterated and the corresponding pixels are darkened or lightened as necessary.

Furthermore, with reference again to FIG. 1, while described herein with specific regards to a windshield 50, it is appreciated that the electrochromic darkening may be applied to any, or all, windows of the vehicle 10. In such an example, the controller 20 uses the same processes to identify a location of the pixels on the particular window on which the electrochromic darkening is included.

In yet further examples, the application of the electrochromic layer and the mapping of head position, pose and gaze may be applied to mirrors such as interior rear view mirrors, and exterior side view mirrors, as well as to windows (including the windshield 50) provided the mirrors include a glass coating over a reflective surface. Mirrors such as these and windows including the windshield are collectively referred to as viewing surfaces.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A vehicle comprising:
at least one window including an electrochromic layer, wherein the at least one window is divided into a set of pixels;
a driver facing camera defining a field of view including a position of a driver;
a controller including a gaze and pose monitoring module and a pixel shading control module, the controller being in communication with the driver facing camera and controllably coupled to the at least one window;
the pixel shading control module being configured to identify a position of at least one object reflected from a drivers eye, mapping the identified position of the at least one object to at least one pixel in the set of pixels, and cause the electrochromic layer to darken the at least one pixel in the set of pixels.

2. The vehicle of claim 1, wherein causing the electrochromic layer to darken the at least one pixel in the set of pixels is performed responsive to a brightness of the reflection of the at least one object exceeding a brightness threshold.

3. The vehicle of claim 1, wherein identifying the position of the at least one object reflected in the driver's eye comprises identifying positions of two or more objects reflected in the driver's eye and wherein mapping of the identified position of the two or more objects to at least one pixel in the set of pixels is performed independently for each object of the two or more objects.

4. The vehicle of claim 1, wherein the at least one window includes a windshield of the vehicle.

5. The vehicle of claim 1, wherein the at least one window further includes at least one side window of the vehicle.

6. The vehicle of claim 1, wherein mapping the identified position of the at least one object to at least one pixel in the set of pixels includes determining a portion of the at least one window through which the driver sees the reflected object based on a position of the reflection in the driver's eye and at least one of a gaze, head position and pose of the driver.

7. The vehicle of claim 1, wherein each pixel in the set of pixels is uniform shaped.

8. The vehicle of claim 7, wherein each pixel in the set of pixels is one of pentagon shaped and hexagon shaped.

9. The vehicle of claim 1, wherein the controller further includes a path planning and positioning module configured to determine a route of the vehicle and determine an expected future location of a sun based on the route of the vehicle, and wherein a pixel shading control module is configured to shade the expected future location of the sun.

10. The vehicle of claim 1, wherein the electrochromic layer comprises at least an inner glass sub-layer and an outer glass sub-layer coated with a conductive coating, and an inner layer of the electrochromic layer, the conductive coating being controllably coupled to the controller.

11. The vehicle of claim 10, wherein the conductive coating is Indium Tin Oxide (ITO).

12. A method for shading a viewing surface of a vehicle comprising:
capturing an image of a driver of a vehicle using an interior facing camera and providing the image to a controller;
identifying a position of at least one object reflected in an eye of the driver;
mapping the identified position of the at least one object to at least one pixel in a set of electrochromic pixels disposed on the viewing surface; and
darkening an electrochromic layer of the at least one pixel responsive to a brightness of a reflection of the at least one object from the eye of the driver exceeding a predefined brightness threshold.

13. The method of claim 12, wherein identifying the position of the at least one object reflected in the eye of the driver comprises identifying positions of two or more objects reflected in the eye of the driver.

14. The method of claim 13, wherein mapping the identified position of the at least one object to at least one pixel in the set of electrochromic pixels comprises independently mapping the identified position each object of the two or more objects to at least one corresponding pixel in the set of pixels.

15. The method of claim 12, wherein the at least one viewing surface includes a windshield of the vehicle.

16. The method of claim 12, wherein the at least one viewing surface further includes at least one side window of the vehicle.

17. The method of claim 12, wherein mapping the identified position of the at least one object to at least one pixel in the set of pixels includes determining a portion of the at least one viewing surface through which the driver sees the reflected object based on a position of the reflection in the driver's eye and at least one of a gaze, head position and pose of the driver.

18. The method of claim 12, wherein each pixel in the set of pixels is one of pentagon shaped and hexagon shaped.

19. The method of claim 12, further comprising determining a route of the vehicle and determine an expected future location of a sun based on the route of the vehicle, and shading the expected future location of the sun.

20. The method of claim 12, wherein the electrochromic layer comprises at least an inner glass sub-layer and an outer glass sub-layer coated with a conductive coating, and an inner layer of the electrochromic coating, the conductive coating being controllably coupled to the controller.
